(19) United States
(12) Patent Application Publication
(10) Pub. No.: US 2025/0155267 A1
(43) Pub. Date: May 15, 2025

(54) Compressed sensing-based Brillouin Frequency Domain Distributed Optical Fiber Sensor Device

(71) Applicant: KOREA PHOTONICS TECHNOLOGY INSTITUTE, Gwangju (KR)

(72) Inventors: Myoung Jin KIM, Gwangju (KR); Young Ho KIM, Gwangju (KR); Joo Young LEE, Jeollanam-do (KR); Hyo Young JUNG, Suwon-si (KR); Hui Oon KIM, Gwangju (KR); Hyo Jong KIM, Gwangju (KR); Jun Gun SHIN, Uiwang-si (KR)

(21) Appl. No.: 18/274,048

(22) PCT Filed: Sep. 23, 2022
(86) PCT No.: PCT/KR2022/014213

§ 371 Date: Jan. 31, 2025

(30) Foreign Application Priority Data
Jul. 21, 2022 (KR) 10-2022-0090226

(51) Int. Cl. G01D 5/353; G01D 5/34; G01K 11/322; G01L 1/24

(52) U.S. Cl. CPC G01D 5/35364; G01D 5/344; G01D 5/35377; G01K 11/322; G01L 1/242

(57) ABSTRACT

The present invention relates to a compressed sensing-based Brillouin frequency domain distributed optical fiber sensor device, and includes: a probe light generation unit that generates probe light using light output from a light source unit and transmits the probe light through one end of a sensing optical fiber; a compressed sensing light generation unit that generates compressed sensing light having a complex signal waveform, in which a plurality of different frequency signals are compressed, using the light output from the light source unit; an optical circulator that receives the compressed sensing light through an input terminal, transmits the same to an output terminal connected to the other end of the sensing optical fiber, and outputs, to a detection terminal, light scattered in the sensing optical fiber and incident through the output terminal; a light detection unit that detects Brillouin scattered light received through the detection terminal; a compressed sensing signal generation unit that generates a compressed sensing signal so that the compressed sensing light is generated; and a signal processing unit that controls the compressed sensing signal generation unit and calculates a temperature or strain for each position of the sensing optical fiber from a signal output from the light detection unit.

### TECHNICAL FIELD

The present invention relates to a compressed sensing-based Brillouin frequency domain distributed optical fiber sensor device, and specifically, to a compressed sensing-based Brillouin frequency domain distributed optical fiber sensor device capable of reducing the number of repeated measurements required to improve position resolution.

### BACKGROUND ART

In recent years, various technologies for measuring physical quantities using optical fibers are proposed and used.

As an example, for an optical fiber grating, when a temperature or a magnitude of a strain is changed, a wavelength of an optical signal reflected from the optical fiber grating changes. Therefore, measuring the change in wavelength of light reflected from the optical fiber grating can be used to measure what magnitudes of physical quantities such as external temperature, strain and pressure was applied from an amount of change in wavelength.

However, the optical fiber grating has a disadvantage in that the manufacturing process is complicated because a process of engraving a grating on an optical fiber is required.

In order to solve the disadvantage, various distributed optical fiber sensors that measure temperature or strain by laying an optical fiber, as it is, are suggested such as Korean Patent Application Publication No. 10-2016-0150458.

Meanwhile, in the case of a method of measuring a physical quantity such as temperature or strain using a Brillouin scattered light scattered in a single-mode optical fiber, pump light with a different frequency is repeatedly supplied in an opposite direction with respect to probe light traveling through the optical fiber. In the case of the method using such pump light, since the number of repeated measurements by modulating differently the frequency increases as the required position resolution increases, there is a need for a method capable of reducing the number of repeated measurements required for position resolution.

### DETAILED DESCRIPTION OF THE INVENTION

### Technical Problem

The present invention has been made to solve the above requirements, and an object thereof is to provide a compressed sensing-based Brillouin frequency domain distributed optical fiber sensor device that can reduce the number of repeated measurements required for position resolution.

### Technical Solution

In order to achieve the above object, a compressed sensing-based Brillouin frequency domain distributed optical fiber sensor device according to the present invention includes a sensing optical fiber installed in a measurement target region; a light source unit configured to output light; a probe light generation unit configured to generate probe light using the light output from the light source unit and to transmit the probe light through one end of the sensing optical fiber; a compressed sensing light generation unit configured to generate compressed sensing light having a complex signal waveform, in which a plurality of different frequency signals are compressed, using the light output from the light source unit; an optical circulator configured to receive the compressed sensing light through an input terminal, to transmit the same to an output terminal connected to the other end of the sensing optical fiber, and to output, to a detection terminal, light scattered in the sensing optical fiber and incident through the output terminal; a light detection unit configured to detect Brillouin scattered light generated in the sensing optical fiber and received through the detection terminal; a compressed sensing signal generation unit configured to generate a compressed sensing signal corresponding to the compressed sensing light so that the compressed sensing light is generated; and a signal processing unit configured to control the compressed sensing signal generation unit and to calculate a temperature or strain for each position of the sensing optical fiber from a signal output from the light detection unit.

In addition, the light source unit includes a light source configured to generate light; and a polarization maintaining coupler configured to distribute the light through a first distribution path and a second distribution path while maintaining a polarization state of the light output from the light source, and the probe light generation unit includes a first modulation unit configured to modulate the light traveling through the first distribution path into the probe light; a polarization switch installed to modulate and output polarization of light output from the first modulation unit; and an optoisolator connected between the polarization switch and one end of the sensing optical fiber so as to block light traveling reversely from one end of the sensing optical fiber.

Further, the compressed sensing light generation unit includes a second modulation unit configured to generate compressed sensing light, which is modulated light corresponding to the compressed sensing signal generated by the compressed sensing signal generation unit, from the light output from the light source unit, and the compressed sensing signal generation unit is configured to generate a modulation signal corresponding to the compressed sensing light including a plurality of different frequencies from the second modulation unit under control of the signal processing unit.

Further, the compressed sensing signal generation unit is configured to control the second modulation unit so that compressed sensing light having a complex frequency waveform expressed as a weighted sum of components of M modulation frequencies {f_{m,min}f_{m,min}+Δfₘ, . . . , f_{m,max}−Δfₘ, f_{m,max}} is output from the second modulation unit, and where the f_{m,min} is the lowest modulation frequency, the f_{m,max} is the maximum modulation frequency, the Δfₘ is a modulation frequency interval, and M is an integer greater than 0.

Further, the signal processing unit is configured to control the compressed sensing signal generation unit so that the compressed sensing light is emitted as many as a number of iterations (N) set smaller than a number of different modulation frequencies (M) compressed in the compressed sensing light, and to calculate a physical quantity for each position of the sensing optical fiber from data received as many as the number of iterations (N) from the light detection unit.

Further, the signal processing unit is configured to calculate the physical quantity for each position by any one restoration algorithm of a matching pursuit-based algorithm, a total variance-based algorithm, a message passing-based algorithm, and a deep learning-based algorithm for a signal received from the light detection unit.

### Advantageous Effects

The compressed sensing-based Brillouin frequency domain distributed optical fiber sensor device according to the present invention provides an advantage of reducing the number of repeated measurements required for position resolution.

### BRIEF DESCRIPTION OF DRAWINGS

FIG. 1 is a diagram showing a compressed sensing-based Brillouin frequency domain distributed optical fiber sensor device according to the present invention.

### BEST MODE

Hereinafter, a compressed sensing-based Brillouin frequency domain distributed optical fiber sensor device according to a preferred embodiment of the present invention will be described in more detail with reference to the accompanying drawing.

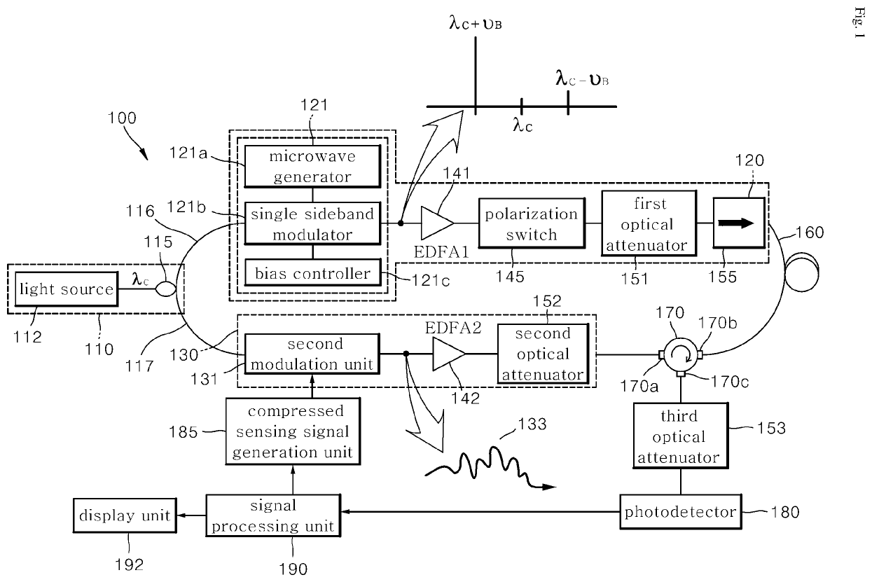

FIG. 1 is a diagram showing a compressed sensing-based Brillouin frequency domain distributed optical fiber sensor device according to the present invention.

Referring to FIG. 1, a compressed sensing-based Brillouin frequency domain distributed optical fiber sensor device 100 according to the present invention includes a light source unit 110, a probe light generation unit 120, a compressed sensing light generation unit 130, a sensing optical fiber 160, an optical circulator 170, a photodetector 180, a compressed sensing signal generation unit 185, and a signal processing unit 190.

The light source unit 110 generates light and distributes the light through a first distribution path 116 and a second distribution path 117.

The light source unit 110 includes a light source 112 and a polarization maintaining coupler 115.

The light source 112 outputs light with a center wavelength (λc) corresponding to a first frequency.

The polarization maintaining coupler 115 distributes the light through the first distribution path 116 and the second distribution path 117 while maintaining a polarization state of the light output from the light source 112.

The polarization maintaining coupler 115 is applied to match polarization states of light traveling through the first distribution path 116 and light traveling through the second distribution path 117, and in this case, the maximum stimulated Brillouin scattering amplification can be obtained.

The light source unit 110 may further include a waveform generator (not shown) that generates a sinusoidal waveform corresponding to the first frequency, and for the light source 112, a distributed feed-back laser diode (DFB LD), which is a semiconductor laser that outputs light modulated with the first frequency so as to correspond to the waveform generated by the waveform generator (not shown), may be applied.

The probe light generation unit 120 is adapted to generate probe light using the light output from the light source 112 and to transmit the probe light through one end of the sensing optical fiber 160.

The probe light generation unit 120 includes a first modulation unit 121, a first amplifier (EDFA1) 141, a polarization switch (PS) 145, an optical attenuator (VOA1) 151, and an optoisolator 155.

The first modulation unit 121 modulates the light output from the light source 112 and traveling the first distribution path 116 into probe light including a sideband signal.

For the first modulation unit 121, a single sideband modulator 121b is applied which generates probe light by modulating an optical signal of the first frequency so as to include a sideband signal with a frequency shifted by an offset frequency (ν_{B}) according to signals generated from a bias controller 121c and a microwave generator 121a. However, the present invention is not limited thereto.

The first amplifier (EDFA1) 141 amplifies an optical signal, and an iridium-doped optical fiber amplifier is applied therefor.

The polarization switch (PS) 145 is installed to modulate and output polarization of the light output from the first modulation unit 121. The polarization switch (PS) 145 can periodically change the polarization of the probe light output from the first modulation unit 121. For example, the polarization switch 145 can receive a signal from a signal generator (not shown), and rotate polarization of the probe light alternately to 0 degree once and 90 degrees the other time according to the received signal. The polarization angles of 0 degree and 90 degrees described above are just illustrative. For example, in another embodiment, the polarization switch 145 may periodically change the polarization of the probe light to an angle different from those described above.

Stimulated Brillouin scattering amplification occurs when the polarizations of the probe light and the compressed sensing light coincide with each other. However, since the polarizations of the probe light and the compressed sensing light can change according to time and space, the polarization problem can be solved by performing measurement while changing the polarization of the probe light using the polarization switch 145, and using an average value of measured values.

The first optical attenuator (variable optical attenuator; VOA1) 151 can attenuate light to a set range, and can be omitted.

The optoisolator 155 is connected between the polarization switch 145 and one end of the sensing optical fiber 160 so as to block light traveling reversely from one end of the sensing optical fiber 160.

The optoisolator 155 serves to block the high-power compressed sensing light from traveling to the first modulation unit 121 via the sensing optical fiber 160, and an optical isolator may be applied.

The sensing optical fiber 160 is installed in a measurement target region, and has one end connected to the optoisolator 155 and the other end connected to an output terminal 170b of the optical circulator 170. For the sensing optical fiber 160, a single-mode optical fiber is preferably applied. In the sensing optical fiber 160, the probe light and the compressed sensing light are incident through one end and the other end so that they travel in opposite directions to each other, and the Brillouin scattered light generated from the sensing optical fiber 160 travels reversely through the optical circulator 170.

The compressed sensing light generation unit 130 generates compressed sensing light 133 having a complex signal waveform, in which a plurality of different frequency signals are compressed, using the light output from the light source 112.

The compressed sensing light generation unit 130 includes a second modulation unit 131, a second amplifier (EDFA2) 142, and a second optical attenuator (VOA2) 152.

The second modulation unit 131 generates the compressed sensing light 133, which is modulated light corresponding to a compressed sensing signal generated in the compressed sensing signal generation unit 185, by using the light output from the light source 112, and Mach-Zehnder modulator (MZM) may be applied therefor.

The second amplifier (EDFA2) 142 amplifies an optical signal, and an iridium-doped optical fiber amplifier is applied therefor.

The second optical attenuator (variable optical attenuator; VOA2) 152 can attenuate light to a set range, and can be omitted.

The optical circulator 170 receives the compressed sensing light through an input terminal 170a, transmits the same to an output terminal 170b connected to the other end of the sensing optical fiber 160, and outputs the light scattered in the sensing optical fiber 160 and incident through the output terminal 170b to a detection terminal 170c.

The third optical attenuator (VOA3) 153 can attenuate the light output from the detection terminal 170c of the optical circulator 170 to a set range, and can be omitted.

The photodetector (PD) 180 is applied as a light detection unit, detects Brillouin scattered light generated in the sensing optical fiber 160 and received through the detection terminal 170c of the optical circulator 170, and provides an electrical signal corresponding to the detected light to the signal processing unit 190.

The compressed sensing signal generation unit 185 generates a compressed sensing signal corresponding to the compressed sensing light so that the compressed sensing light is generated in the second modulation unit 131, and provides the same to the second modulation unit 131.

The compressed sensing signal generation unit 185 generates a compressed sensing signal, which is a modulation signal corresponding to generation of the compressed sensing light including a frequency of f1 to fm, from the second modulation unit 131 under control of the signal processing unit 190.

The signal processing unit 190 controls the compressed sensing signal generation unit 185, and calculates a physical quantity, e.g., temperature or strain for each position of the sensing optical fiber 160 from a signal output from the photodetector 180.

The signal processing unit 190 controls the compressed sensing signal generation unit 185 so that the compressed sensing light is emitted as many as a number of iterations set smaller than a number of different frequency signals compressed in the compressed sensing light, calculates a physical quantity, e.g., temperature or strain for each position of the sensing optical fiber 160 from data received as many as the number of iterations from the photodetector 180, and outputs a calculation result to a display unit 192 exemplified as an output device.

Below, the operating method of the optical fiber sensor devices 100 will be described in more detail.

First, regarding the position resolution of the sensing optical fiber 160, in a method of the related art in which the modulation frequency output from the second modulation unit 131 is single and the modulation frequency is applied differently for each repeated measurement, the maximum measurement distance resolution is determined by the modulation frequency f_{m,min}, . . . , f_{m,max}) applied differently for each measurement. Here, f_{m,min} is the lowest modulation frequency to be applied, and f_{m,max} is the maximum modulation frequency to be applied.

In this case, the distance resolution (Δz) can be expressed by Formula 1 below.

$$Δ z = \frac{c}{2 n} \frac{1}{{f}_{m , max} - {f}_{m , min}}$$

here, c is the speed of light, and n is the refractive index of light in the sensing optical fiber 160.

In addition, the maximum measuring distance Lₘₐₓ can be expressed by Formula 2 below.

$${L}_{max} = \frac{c}{2 n} \frac{1}{Δ {f}_{m}} \qquad [ Formula 2 ]$$

here, Δfₘ is a modulation frequency interval.

Therefore, according to the BOFDA (Brillouin Optical Frequency Domain Analysis) system of the related art, the measurement should be performed for each modulation frequency with respect to the entire modulation frequencies {f_{m,min}, . . . , f_{m,max}} that are applied in order to obtain the distance resolution (Δz) and the maximum measuring distance (Lₘₐₓ), and the number of measurements (M) can be expressed by Formula 3 below.

$$M = \frac{{f}_{m , max} - {f}_{m , min}}{Δ {f}_{m}} \qquad [ Formula 3 ]$$

Meanwhile, when the transfer function H(fₘ) is measured in order to obtain the physical properties of the sensing optical fiber 160, the transfer function H(fₘ) is transformed to a first value (h(t)) by inverse FFT (IFFF), and the first value (h(t)) is restored to a physical quantity (h(z)) for each distance through distance transformation. This process can be expressed as follows.

$$H ( {f}_{m} ) {\to }^{IFFT} h ( t ) {\to }^{z = \frac{t c}{2 n}} h ( z )$$

here, t is time.

The BOFDA system of the related art is based on a concept of sampling the transfer function at discrete modulation frequencies. In other words, in the first measurement, the pump light with the lowest modulation frequency (f_{m,min}) is output to acquire a Brillouin scattering signal, and in the second measurement, the pump light with the second modulation frequency (f_{m,min}+Δfₘ), which is different from the lowest modulation frequency f_{m,min}) by the modulation frequency interval (Δfₘ), is output to acquire a Brillouin scattering signal. In this way, the process of repeatedly performing measurement while increasing the modulation frequency is performed until the maximum modulation frequency f_{m,max}) is generated and output to acquire a Brillouin scattering signal.

However, the physical quantity (h(z)) for each distance measured through the sensing optical fiber 160 has a changed value only at a specific location, in many cases. That is, the amount of information is often less than the number of measurements (M). However, according to the method of the related art, it is essential to perform measurement M times in order to restore a signal.

On the other hand, the compressed sensing-based Brillouin frequency domain distributed optical fiber sensor device 100 proposed in the present invention makes it possible to achieve the same distance resolution (Δz) and maximum measuring distance (Lₘₐₓ) as the related art only with N measurements (N«M) by using a complex frequency waveform expressed by a weighted sum of components of the modulation frequencies {f_{m,min}, . . . , f_{m,max}}.

More specifically, it is first assumed that the amount of information contained in h(z) is less than M. This expresses that the signal has sparsity characteristics. When the signal has sparsity characteristics, the measuring quantity can be greatly reduced by using the compressed sensing technique. The compressed sensing is a technique that can restore the original signal from undersampled data.

The compressed sensing signal generation unit 185 generates a compressed sensing-based complex frequency waveform to be used for N measurements.

The complex frequency waveform(g) is calculated by a product of the modulation frequency vector f=f_{m,min}, . . . , f_{m,max})^{T}∈R^{M} and the compressed sensing measurement matrix A∈R^{N×M}. Here, T is a transpose matrix operator, R is a real number region, M is the number of entire modulation frequencies to be applied in the method of the related art, i.e., the number of measurements, and N is the number of measurements when the method proposed in the present invention is applied.

$$g = {( {g}_{1} , {g}_{2} , … , {g}_{N} )}^{T} = A \cdot f ∈ {R}^{M}$$

Here, g is the complex frequency waveform described above.

In addition, A is a measurement matrix, and should satisfy a restricted isometry property (RIP) condition. The RIP condition means a characteristic of preserving an orthogonal property of a sparse signal. Examples of the measurement matrix A include a random Gaussian matrix, a Bernoulli matrix, a partial Fourier transform matrix, and the like. Meanwhile, when performing measurement under conditions of the length of the sensing optical fiber 160 of 10 km and the distance resolution (Δz) of 0.25 m, according to the method of the related art, 40,000 measurements are required, and the measurement should be performed at the intervals of 5 kHz to 210 MHz and 5 kHz interval with f=(5 kHz, 10 kHz, 15 kHz, . . . , 210 MHz)^{T}. On the other hand, when the compressed sensing technique proposed in the present invention is applied, the original signal can be restored with 5% to 30% of the measurement, theoretically.

If the existing measurement signal is H(f)=(H(f_{m,min}), . . . , H(f_{m,max}))^{T}∈R^{M}, the compressed sensing measurement signal (y) is y=H(g)=H(A·f)=A·H(f)∈R^{N}. Here, T is a transpose matrix operator, R is a real number region, M is the number of entire modulation frequencies to be applied in the method of the related art, i.e., the number of measurements, and N is the number of measurements when the method proposed in the present invention is applied.

Since the transfer function of a Brillouin frequency domain measurement system has a linear time invariant property in the frequency domain, the distributive law holds for synthesis. The existing physical quantity distribution for each distance is assumed as h(z)∈R^{M}, F·h(z)=H(f) is expressed. Here, F is a Fourier transform matrix. F⁻¹ is an inverse Fourier transform matrix, and it is a distance sample z=(z₁, z₂, . . . , z_{M})^{T}∈R^{M} vector.

Combining the above formula gives

$$y = A \cdot H ( f ) = A \cdot F \cdot h ( z )$$

The restoration of the compressed sensing measurement signal (y) is performed in the process of solving the following optimization problem.

$$min {‖ h ( z ) ‖}_{0}$$

$$Subject to y = AF \cdot h ( z ) ,$$

Here, min∥h(z)∥₀ is an objective function and, Subject to is a constraint.

Meanwhile, for a restoration algorithm that is applied in the signal processing unit 190, any one of a matching pursuit-based algorithm, a total variance-based algorithm, a message passing-based algorithm, and a deep learning-based algorithm may be used.

The compressed sensing-based Brillouin frequency domain distributed optical fiber sensor device described above provides an advantage of reducing the number of repeated measurements required for position resolution.

1. A compressed sensing-based Brillouin frequency domain distributed optical fiber sensor device comprising:
a sensing optical fiber installed in a measurement target region;
a light source unit configured to output light;
a probe light generation unit configured to generate probe light using the light output from the light source unit and to transmit the probe light through one end of the sensing optical fiber;
a compressed sensing light generation unit configured to generate compressed sensing light having a complex signal waveform, in which a plurality of different frequency signals are compressed, using the light output from the light source unit;
an optical circulator configured to receive the compressed sensing light through an input terminal, to transmit the same to an output terminal connected to the other end of the sensing optical fiber, and to output, to a detection terminal, light scattered in the sensing optical fiber and incident through the output terminal;
a light detection unit configured to detect Brillouin scattered light generated in the sensing optical fiber and received through the detection terminal;
a compressed sensing signal generation unit configured to generate a compressed sensing signal corresponding to the compressed sensing light so that the compressed sensing light is generated; and
a signal processing unit configured to control the compressed sensing signal generation unit and to calculate a temperature or strain for each position of the sensing optical fiber from a signal output from the light detection unit.

2. The compressed sensing-based Brillouin frequency domain distributed optical fiber sensor device according to claim 1, wherein the light source unit comprises:
a light source configured to generate light; and
a polarization maintaining coupler configured to distribute the light through a first distribution path and a second distribution path while maintaining a polarization state of the light output from the light source, and
wherein the probe light generation unit comprises:
a first modulation unit configured to modulate the light traveling through the first distribution path into the probe light;
a polarization switch installed to modulate and output polarization of light output from the first modulation unit; and
an optoisolator connected between the polarization switch and one end of the sensing optical fiber so as to block light traveling reversely from one end of the sensing optical fiber.

3. The compressed sensing-based Brillouin frequency domain distributed optical fiber sensor device according to claim 1, wherein the compressed sensing light generation unit comprises a second modulation unit configured to generate compressed sensing light, which is modulated light corresponding to the compressed sensing signal generated by the compressed sensing signal generation unit, from the light output from the light source unit, and
wherein the compressed sensing signal generation unit is configured to generate a modulation signal corresponding to the compressed sensing light comprising a plurality of different frequencies from the second modulation unit under control of the signal processing unit.

4. The compressed sensing-based Brillouin frequency domain distributed optical fiber sensor device according to claim 3, wherein the compressed sensing signal generation unit is configured to control the second modulation unit so that compressed sensing light having a complex frequency waveform expressed as a weighted sum of components of M modulation frequencies {f_{m,min}, f_{m,min}+Δfₘ, . . . , f_{m,max}−Δfₘ, f_{m,max}} is output from the second modulation unit, and
where the f_{m,min} is the lowest modulation frequency, the f_{m,max} is the maximum modulation frequency, the Δfₘ is a modulation frequency interval, and M is an integer greater than 0.

5. The compressed sensing-based Brillouin frequency domain distributed optical fiber sensor device according to claim 4, wherein the signal processing unit is configured to control the compressed sensing signal generation unit so that the compressed sensing light is emitted as many as a number of iterations (N) set smaller than a number of different modulation frequencies (M) compressed in the compressed sensing light, and to calculate a physical quantity for each position of the sensing optical fiber from data received as many as the number of iterations (N) from the light detection unit.

6. The compressed sensing-based Brillouin frequency domain distributed optical fiber sensor device according to claim 5, wherein the signal processing unit is configured to calculate the physical quantity for each position by any one restoration algorithm of a matching pursuit-based algorithm, a total variance-based algorithm, a message passing-based algorithm, and a deep learning-based algorithm for a signal received from the light detection unit.
